(19) United States
(12) Patent Application Publication
(10) Pub. No.: US 2006/0049901 A1
(43) Pub. Date: Mar. 9, 2006

(54) Electromagnetic actuator

(75) Inventors: Martin Bottcher, Berlin (DE); Marcus Kampf, Berlin (DE); Carsten Protze, Dresden (DE)

Correspondence Address: MORRISON & FOERSTER LLP, 1650 TYSONS BOULEVARD, SUITE 300, MCLEAN, VA, 22102, US

(73) Assignee: Siemens AG, Munchen (DE)

(21) Appl. No.: 10/539,576

(22) PCT Filed: Dec. 18, 2003
(86) PCT No.: PCT/DE03/04205

§ 371 Date: Jun. 17, 2005

(30) Foreign Application Priority Data
Dec. 19, 2002 (DE) 10261811.9

(51) Int. Cl. H01F 7/08

(52) U.S. Cl. 335/229

(57) ABSTRACT

According to the invention, an electromagnetic actuator (1) for a switch, operating in the medium voltage range, comprising at least one magnet body (2, 3), defining an air gap, a moving body (5), arranged in the air gap (4), guided to move relative to the magnet body (2, 3), at least one permanent magnet and at least one conductor (6), through which a current may flow, whereby the conductor(s) (6) extend(s) at least partly into a magnetic field generated by the permanent magnets on a movement of the moving body (5), may be produced such as to be able to be fixed in the end positions thereof in a simple manner, whereby the moving body (5) is fixed to at least one soft-magnetic locking body (7) and the magnetic field generated by the permanent magnet(s) (3) flows through the locking body (7) in an end position of the moving body (5) in which the air gap (4) for the magnetic field is bridged by the locking body (7).

The invention relates to an electromagnetic drive for a switch, in particular in the medium-voltage sector, having at least one magnet body which delimits an air gap, a moving part which is arranged in the air gap and is guided such that it can move with respect to the magnet body, at least one permanent magnet and at least one conductor to which current can be supplied, the conductor(s) extending at least partially in a magnetic flux produced by the permanent magnet(s) during movement of the moving part.

Such an electromagnetic drive is known, for example, from DE 198 15 538 A1. The drive disclosed therein has a three-phase linear motor which is composed of two or more motor modules. The motor module has a specific number of fixed motor coils and moving parts, which are guided such that they can move longitudinally with respect to said fixed motor coils, having permanent magnets. Excitation of the motor coils produces a magnetic field in which the permanent magnets of the moving part are arranged. The Lorentz force produced results in a drive movement of the moving part which is connected to the moving contact of a switch via a switching rod. In order to switch the vacuum interrupter on, the moving contact is pressed against a fixed contact of the switch by the three-phase linear motor, the moving part reaching an end position.

WO 95/07542 discloses an electromagnetic drive which has a yoke made of soft-magnetic material which runs continuously in the form of a frame and is composed of stacked laminates for the purpose of preventing eddy currents. The yoke forms a cavity in which an armature, which is made of a soft-magnetic material, is guided such that it can move between two end positions. In each end position, one of the end faces of the armature makes contact with the soft-magnetic yoke, an air gap being defined between the other end face of the armature, which lies opposite the contact point, and the continuously circumferential yoke. In addition, two coils are fixed in the cavity of the yoke and each surround one of the end faces of the armature. Permanent magnets are provided between the coils for the purpose of producing a magnetic flux. Owing to the air gap, the armature remains fixed in the respective end position. Owing to the excitation of the coil which surrounds the end face on the side of the air gap, a magnetic flux is produced in the air gap which is so high that the armature is released from the yoke in order to reduce the magnetic reluctance and is changed to its second, stable end position so as to close the air gap, in which end position it bears against the yoke with its other end face which previously delimited the air gap. The field current in the coil can now be interrupted since the armature is also fixed in this end position.

The two previously known magnet drives described above are based on different physical effects. The electromagnetic drive in accordance with DE 198 15 538 A1 makes use of the so-called Lorentz force, which is produced in a magnetic field when charged particles move, for the purpose of producing the drive action. The action of an electromagnetic drive in accordance with WO 95/07542 can be put down to the physical effect consisting of a magnetic field preferably propagating in a material having high magnetic permeability or, in other words, in a material having low magnetic reluctance. Owing to the displacement of the armature, the entire system is changed from an energetically unfavorable state having a high magnetic potential to an energetically more favorable state in which an air gap is closed and the magnetic flux passes almost exclusively through a material having a low magnetic reluctance. The force required for changing the system to the energetically favorable state results from gradient forming. Drives which are based on such an effect are also known as reluctance drives.

Electromagnetic drives which are based on the Lorentz force have a high dynamic response and can furthermore be controlled in a simple manner, namely via the current passed through the magnetic field. However, one disadvantage is the fact that these drives cannot assume stable end positions or intermediate positions but need to be fixed in the respectively envisaged end positions using additional means, if required. For this purpose, springs, catches or the like are usually used, whose force can be eliminated only with difficulty. Reluctance drives are generally characterized by being fixed in a stable manner in their end position. However, they do have the disadvantage of a very nonlinear travel/force characteristic which can be influenced either only with difficulty or else to the detriment of the holding force in the end positions or to the detriment of the physical space.

It is therefore the object of the invention to provide an electromagnetic drive of the type mentioned initially which can be fixed in its end positions in a simple manner, but with which simple control of the drive movement is maintained.

The invention achieves this object by the moving part being fixedly connected to at least one soft-magnetic latching body and by the magnetic flux produced by the permanent magnet(s) passing through the latching body in an end position of the moving part, the air gap being bridged by the latching body for the magnetic flux.

The electromagnetic drive according to the invention makes use of both the Lorentz force and the force resulting from a reduction in the magnetic reluctance or, in other words, the reluctance force. For this purpose, an air gap, which increases the magnetic reluctance for the magnetic flux, is bridged in at least one end position by the latching body. The moving part has thus assumed an energetically favorable state. Once the latching body has been released from its end position, the magnetic flux is forced to flow via the air gap provided in the magnet body or else via air gaps of increasing size and formed between the magnet body and the latching body, as a result of which the magnetic reluctance is increased. In this way, a magnetically less favorable state is set as regards the end position. A magnetic force counteracting the release is produced. The moving part can be connected to a movable switching contact of a switch, in particular a vacuum interrupter, via an expedient mechanism, for example drive rods and force transmission levers. In this case, the movable switching contact is in fixed contact with a stationary contact piece of the switch in an end position of the drive.

When current flows via the contacts of the switch, mutually repelling forces are produced by the constrictions forming on the contacts. The latching in the end position of the drive prevents the contacts from lifting off from one another and thus the formation of a high-energy arc, in particular in the case of a short circuit.

The force which is based on the reduction in the magnetic reluctance for the magnetic flux has a very nonlinear characteristic since high forces are produced in the event of there being small gaps between the latching body and the magnet body. In the case of average displacement positions when the latching body is spaced further apart from the yoke, the drive takes place almost exclusively by means of Lorentz forces. The electromagnetic drive according to the invention can therefore be controlled in a simple manner in the central displacement positions of the moving part, namely either by expediently feeding the conductor with current or by changing the magnetic flux which is produced electromagnetically by means of coils. In the end positions, however, a sufficiently high latching force is at the same time provided in order to prevent a movable switching contact from being lifted off from a stationary opposing contact, even in the event of a short circuit.

In this case, it is in no way necessary for the latching body to bear against the regions of the magnet body (bodies) which delimit the air gap for bridging purposes. Rather, the latching body may also be held at a short distance from these regions such that, for example, a permanent pressure force can be produced for the switching contact against the fixed contact of the switch in these cases. However, it is essential that the magnetic reluctance is minimized in the end position with respect to other possible displacement positions.

Permanent magnets, for example, are fixed to the moving part, the magnetic flux produced by them and possibly also that produced by the conductor flowing partially via the latching body in an end position of the latching body such that the reluctance of the entire magnetic circuit is minimized in the end position.

In contrast to this, the moving part has at least one coil having a former which has the conductor wound around it, each latching body being connected to one end of the coil. In accordance with this expedient development of the invention, the electromagnetic drive is a linear drive, the movement of the electromagnetic drive essentially corresponding to the length of the coil (s). The latching bodies may be arranged on one or both sides of a coil. If the moving part has, for example, two latching bodies and one coil, it is fixed in two end positions. The influence of the latching body on the force/distance characteristic of the drive is greater than that in the case of the variant having one latching body.

In accordance with a further advantageous development, the magnet body comprises a soft-magnetic yoke in addition to the permanent magnet(s), the magnetic flux produced by each permanent magnet passing through the yoke. The use of a yoke for guiding the magnetic flux contributes to reducing costs since the air gap need not be introduced into a large and therefore cost-intensive permanent magnet. Rather, the use of a smaller permanent magnet is sufficient. The yoke is advantageously in the form of a ring or a frame, a magnetic circuit being formed by the, for example, rectangular frame, said magnetic circuit being interrupted only by an air gap interrupting the frame profile. In order to prevent eddy currents, the yoke is composed of stacked laminates. The magnet body and thus the permanent magnet(s) are stationary in relation to the moving part. Since the moving part enters the air gap when the drive movement is generated, this development of the invention is also referred to as a drive which is based on the plunger-type coil principle. Such a drive, in contrast to drives based on the three-phase linear motor principle, manages with a DC voltage which can be obtained from only one phase of a three-phase system.

In one preferred exemplary embodiment, each latching body bears against the soft-magnetic yoke in the end position associated with said latching body. An air gap between the latching body and the magnet body is thus prevented in the end position. The magnetic flux travels directly from the magnet body into the latching body, as a result of which the magnetic reluctance of the magnetic circuit is minimized. The moving part is thus latched particularly fixedly in the end position.

A spring is advantageously provided for the purpose of releasing the moving part from its end position. The holding force in the respective end position can be reduced or even eliminated by appropriately passing a current through the coil. However, the spring assists in releasing the moving part from the end position. Suitable springs are, for example, compression springs which are supported on a stationary abutment, on the one hand, and on that end of the latching body which is remote from the coil.

In a different development of the invention, the moving part is mounted on a shaft and can be rotated, each latching body bearing against stops, which are connected to the magnet body, in an end position. In this development according to the invention, the electromagnetic drive is not a linear motor but produces a rotary movement which is carried outside via the shaft, i.e. in the form of a rotary movement. In accordance with this development, the magnet body may have electromagnets which produce a traveling magnetic field.

However, the magnet body preferably has a yoke having a permanent magnet, the magnetic flux produced by the permanent magnet passing through the cutout formed in the magnet body or, in other words, the air gap. The moving part is designed to essentially fit the hollow-cylindrical air gap and is mounted in said air gap such that it can rotate by means of the shaft. Excitation of the conductor of the moving part produces a rotary movement. The conductor may be in the form of, for example, a winding which is fed by one current phase. However, the conductor may also be formed by two or more windings which are excited by two or more current phases such that a traveling field is produced. The end positions are defined by the positioning of two stops which are fixedly connected to the magnet body. In the end position region, the latching body, which is, for example, in the form of a rod, abuts against the stops with its opposite end regions such that, in the end position, bridging of the stops is provided by means of the latching body. The magnetic flux is now no longer forced to pass through the air gap but passes from one stop to the other via the latching body against little magnetic reluctance.

The moving part is expediently designed to be rotationally symmetrical, and the conductor is in the form of at least one winding on the moving part.

Further expedient refinements and advantages of the invention are the subject matter of the description below of exemplary embodiments with reference to the figures of the drawing, in which corresponding components are provided with the same references, and in which:

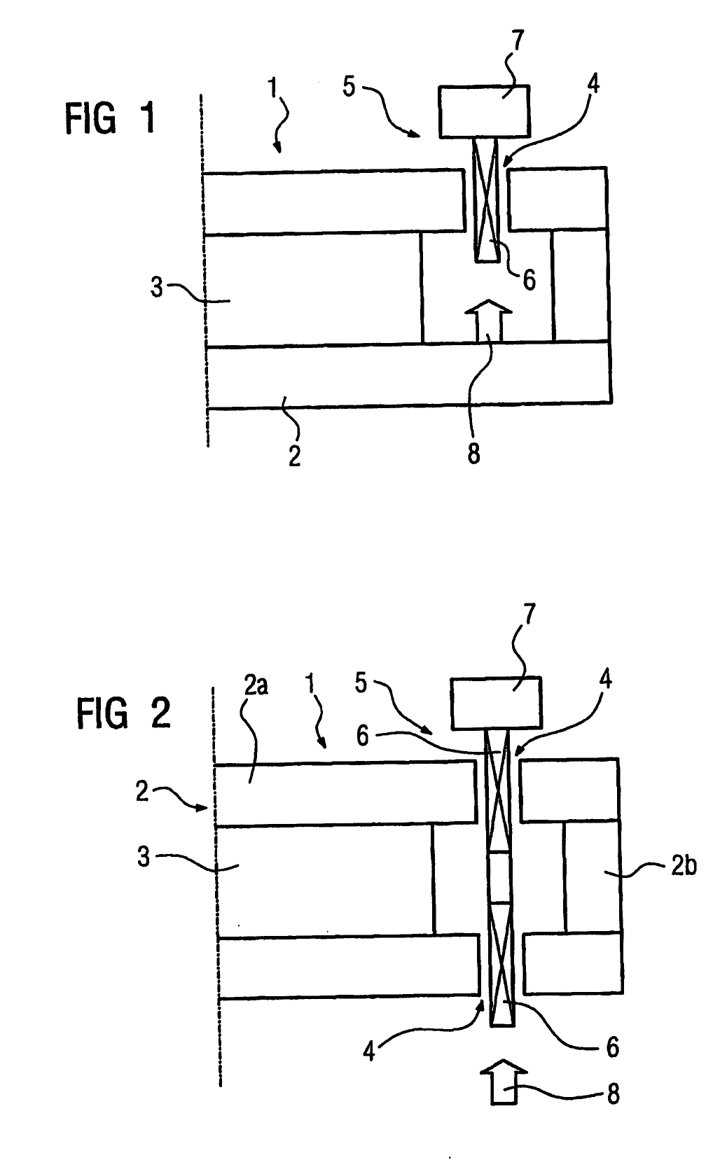

FIG. 1 shows a schematic illustration of one exemplary embodiment of the electromagnetic drive according to the invention,

FIG. 2 shows a schematic illustration of a further exemplary embodiment of an electromagnetic drive according to the invention,

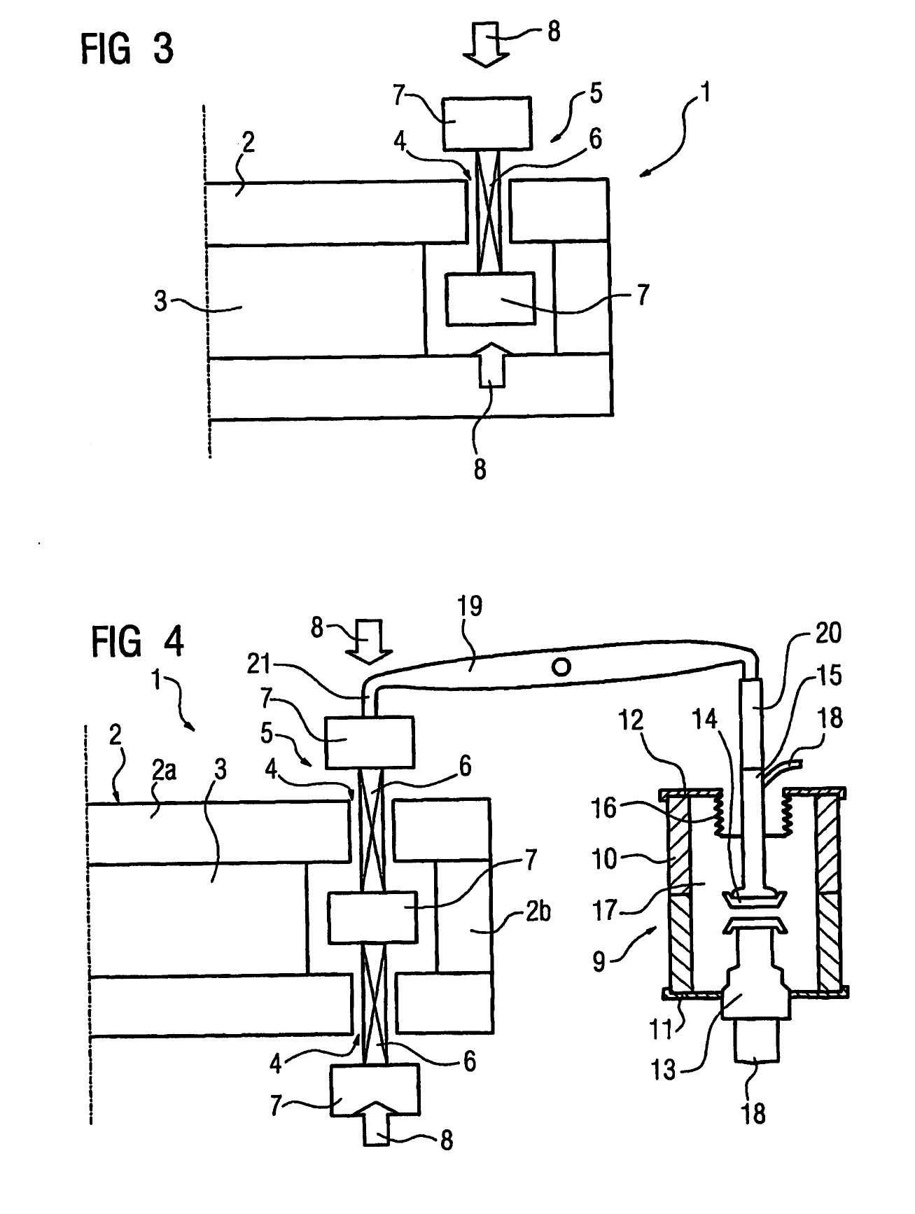

FIG. 3 shows a schematic illustration of a further exemplary embodiment of the electromagnetic drive according to the invention,

FIG. 4 shows a schematic illustration of a further exemplary embodiment of the electromagnetic drive according to the invention, and

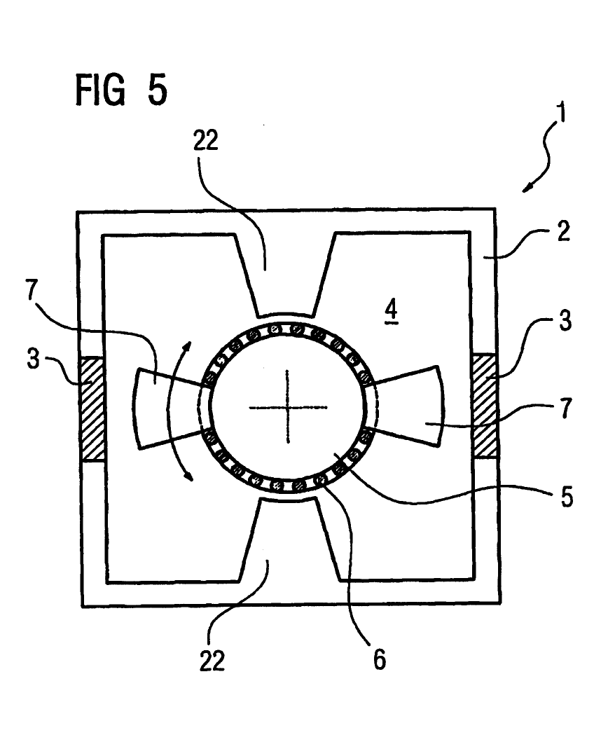

FIG. 5 shows a schematic illustration of a further exemplary embodiment of the electromagnetic drive according to the invention.

FIG. 1 shows a schematic illustration of one exemplary embodiment of the electromagnetic drive 1 according to the invention. The electromagnetic drive shown has a magnet body comprising a yoke 2 and a permanent magnet 3, in which magnet body an air gap 4 is provided. The magnet body 2, 3 and the air gap 4 form a magnetic circuit for the magnetic flux produced by the permanent magnet 3, the air gap 4 representing a region having greater magnetic reluctance than the magnet body 2, 3. A moving part 5, which is composed of a coil 6 and a latching body 7, protrudes into the air gap 4 through which a magnetic flux or magnetic field passes. The coil 6 has a nonconductive coil former, for example made of plastic, which has conductors wound around it which are in contact with one another and are insulated from one another on the outside. The section of the coil 6 which protrudes into the air gap 4 is subjected to the magnetic flux produced by the permanent magnet 3, with the result that a Lorentz force is produced by the coil being excited with current, said Lorentz force moving the moving part 5 into or out of the air gap 4 depending on the current direction. In this way, a linear movement is provided which can be used as a drive movement, for example, for the interrupter unit in a medium-voltage power switchgear assembly.

If the moving part 5 is drawn into the air gap 4 owing to the Lorentz force and if double the distance between the latching body 7 and the yoke 2 is less than the diameter of the air gap 4, the magnetic reluctance of the magnetic circuit is reduced. The air gap 4 is bridged by means of the latching body 7. If the latching body 7 bears completely against the soft-magnetic yoke 2, a continuous magnetic flux is made possible exclusively by means of materials which have high permeability and thus low magnetic reluctance. This state is thus energetically more favorable than a magnetic circuit having an air gap. Any displacement of the moving part 5 into a position in which the latching body 7 is at a distance from the yoke 2 therefore acts counter to a force gradient. The latching body 7 is latched on the yoke 2.

In order to release the latching body 7 from the yoke 2, a spring 8, which is illustrated only schematically in FIG. 1, is provided which is in the form of, for example, a helical spring and is supported at one end on the yoke 2 and at the other end on the coil 6. If the latching body 7 bears against the yoke 2, the spring 8 is prestressed. By feeding the coil 6 with current, the permanent magnet field produced by the holding force is weakened to such an extent that the spring 8 accelerates the moving part 5 out of the end position. The spring 8 may furthermore be used for the purpose of producing a permanent pressure force for a moving contact of a vacuum interrupter against its stationary fixed contact, the moving contact being mechanically connected to the moving part 5 via an expedient rod and lever arrangement in order to introduce the movement of the moving part into the moving contact.

FIG. 2 shows a further exemplary embodiment of an electromagnetic drive 1 according to the invention. In the exemplary embodiment shown, the yoke 2 which comprises two parts 2a and 2b has two air gaps 4, two coils 6 of the moving part 5 extending into a respective air gap 4. The component of the Lorentz force is thus greater than the force resulting from the reduction in the magnetic reluctance.

FIG. 3 shows a schematic illustration of a further exemplary embodiment of the electromagnetic drive 1 according to the invention. As in FIG. 1, only one air gap 4 is provided in the soft-magnetic yoke 2. In contrast to the exemplary embodiment shown in FIG. 1, the moving part has, however, two latching bodies 7 which are arranged on both sides of the coil 6. The movement of the moving part 5 is therefore limited on both sides such that two end positions are defined in which one of the latching bodies 7 bears against the soft-magnetic yoke 2 and the moving part 5 is located in the latched position. In order to release the two latching bodies, two springs 8 are provided which are arranged opposite one another in the movement direction of the moving part 5 and are each supported with one of their ends on the latching body 7 associated with them, whereas the other spring end rests on an abutment provided fixedly with the yoke 2.

FIG. 4 shows, as in FIG. 2, an exemplary embodiment of the electromagnetic drive according to the invention, in the case of which the soft-magnetic yoke 2 is composed of two parts 2a and 2b and two air gaps 4 are formed. The moving part 5 has two coil sections 6 which extend into a respective air gap 4. In contrast to FIG. 2, the moving part 5 in accordance with FIG. 4 has three latching bodies 7. The moving part 5 can therefore only be displaced between two end positions in which in each case two latching bodies 7 bear against the soft-magnetic yoke 2 such that the two air gaps 4 are bridged. In order to release the latching bodies 7, two compression springs 8 are in turn provided which are opposite one another in the movement direction of the moving part 5 and are in each case supported at one end on the latching body 7 and at the other end on a stationary abutment (not shown).

In addition, FIG. 4 schematically illustrates a vacuum interrupter 9 which is composed of a hollow-cylindrical, nonconductive ceramic section 10 and metallic end faces 11 and 12. A stationary fixed contact 13 passes through the end face 11, and a moving contact 14, which is guided such that it can move axially, is arranged axially opposite said fixed contact 13. The moving contact 14 is held by a conductive switching rod 15 which passes through a metal bellows 16, which provides the axial freedom of movement of the moving contact. A vacuum chamber 17 is formed between the ceramic section 10, the end walls 11 and 12 and the metal bellows 16, and a vacuum is applied to said vacuum chamber 17. Terminals 18 which are only illustrated schematically are provided for the purpose of connecting the current. The movement of the drive is introduced into the vacuum interrupter via a lever 19 and a transmission rod 20 which is produced from a nonconductive material, the lever 19 being connected to the drive 1 by schematically illustrated transmission means 21. A contact pressure spring, which is arranged, for example, in the transmission rod 20, is provided for the purpose of producing the necessary pressure force for the contacts.

FIG. 4 shows the vacuum interrupter 9 in an intermediate position. In a contact position (not shown), on the other hand, the moving contact 14 makes contact with the fixed contact 13 so as to make current flow possible. In this case, the lowest latching body 7 and the central latching body 7 bear against the yoke 2 such that the contact position of the vacuum interrupter 9 is latched. The moving contact 14 is thus prevented from being lifted off from the fixed contact 13 owing to constriction forces. In a disconnected position, the upper latching body 7 and the central latching body 7 bear against the yoke 2, but with the central latching body on the lower frame section.

In the exemplary embodiments shown in FIG. 3 and FIG. 4, the influence of the latching body 7 and thus the component of the reluctance force is greater than the Lorentz force.

FIG. 5 shows a further exemplary embodiment of the electromagnetic drive 1 according to the invention. The electromagnetic drive 1 shown there has a magnet body comprising a soft-magnetic yoke 2 and two permanent magnets 3, the magnet body being essentially in the form of a frame and having two projections 22 which point towards one another in the form of truncated wedges. The projections 22 delimit the air gap 4. The moving part 5 is mounted in the air gap 4, such that it can rotate, by means of a shaft (not shown in FIG. 5) and is provided with a conductor in the form of a winding or, in other words, a coil 6, which in this case can be excited by only one phase of a three-phase system.

In addition, two latching bodies 7, which are likewise in the form of truncated wedges and are fixedly connected to the moving part 5 on mutually opposing sides of said moving part 5, are provided on the moving part 5.

The magnetic flux produced by the permanent magnet 3 chooses the path of least magnetic reluctance and passes through the projections 22 and thus the moving part 5 as well as the coil 6. Owing to the excitation of the coil 6, a rotary movement of the moving part 5 results owing to the Lorentz force, and in this way a drive force is produced for a vacuum interrupter of an electrical switchgear assembly. In one contact position of the switching contacts of the vacuum interrupter, the mutually opposing latching bodies 7 bear against the projections 22 such that the magnetic flux passes through the projections 22, the latching bodies 7 and the moving part 5. In this case, the latching bodies 7 are produced from a ferromagnetic material such that the magnetic reluctance is reduced owing to bridging of the air gap 4. The end positions of the electromagnetic drive 1 are therefore latched owing to the reluctance force.

1. An electromagnetic drive (1) for a switch, in particular in the medium-voltage sector, having at least one magnet body (2, 3) which delimits an air gap, a moving part (5) which is arranged in the air gap (4) and is guided such that it can move with respect to the magnet body (2, 3), at least one permanent magnet and at least one conductor (6) to which current can be supplied, the conductor(s) (6) extending at least partially in a magnetic flux produced by the permanent magnet(s) in the event of a movement of the moving part (5),
characterized in that
the moving part (5) is fixedly connected to at least one soft-magnetic latching body (7), and in that the magnetic flux produced by the permanent magnet(s) (3) passes through the latching body (7) in an end position of the moving part (5), the air gap (4) being bridged by the latching body (7) for the magnetic flux.

2. The electromagnetic drive (1) as claimed in claim 1,
characterized in that
the moving part (5) has at least one coil (6) having a former, which has the conductor wound around it, each latching body being connected to one end of the coil (6).

3. The electromagnetic drive (1) as claimed in claim 1,
characterized in that
the magnet body comprises the permanent magnet(s) (3) and a soft-magnetic yoke (2), the magnetic flux produced by each permanent magnet (3) passing through the yoke (2).

4. The electromagnetic drive (1) as claimed in claim 3,
characterized in that
each latching body (7) bears against the soft-magnetic yoke (2) in the end position associated with said latching body (7).

5. The electromagnetic drive (1) as claimed in claim 1,
characterized in that
at least one spring (8) is provided for the purpose of releasing the moving part (5) from an end position.

6. The electromagnetic drive (1) as claimed in claim 1,
characterized in that
the moving part (5) is mounted on a shaft and can be rotated, and each latching body bears against stops, which are connected to the magnet body, in an end position of the moving part.

7. The electromagnetic drive as claimed in claim 6,
characterized in that
the moving part (5) is designed to be rotationally symmetrical, and the conductor is in the form of at least one winding on the moving part (5).
